(19) United States
(12) Patent Application Publication
(10) Pub. No.: US 2021/0080163 A1
(43) Pub. Date: Mar. 18, 2021

(54) CONTROL DEVICE, COMPRESSOR, ELECTRIC COMPRESSOR, BELT-DRIVEN COMPRESSOR, VEHICLE AIR CONDITIONER, AND CONTROL METHOD

(71) Applicant: MITSUBISHI HEAVY INDUSTRIES THERMAL SYSTEMS, LTD., Tokyo (JP)

(72) Inventors: Katsuhiro FUJITA, Tokyo (JP); Takahide YAMAMOTO, Tokyo (JP); Tetsuzou UKAI, Tokyo (JP)

(73) Assignee: MITSUBISHI HEAVY INDUSTRIES THERMAL SYSTEMS, LTD., Tokyo (JP)

(21) Appl. No.: 16/971,235

(22) PCT Filed: Jan. 18, 2019
(86) PCT No.: PCT/JP2019/001442

§ 371 Date: Aug. 19, 2020

(30) Foreign Application Priority Data
Mar. 28, 2018 (JP) 2018-062063

(51) Int. Cl. F25B 49/02; B60H 1/32

(52) U.S. Cl. CPC F25B 49/022; B60H 1/3205; F25B 2600/021; F25B 2600/2513; F25B 2700/1933; B60H 2001/3272

(57) ABSTRACT

Provided is a control device that performs protection control of a compressor without malfunction. The control device activates protection control on a compressor included in a refrigerant circuit based on a pressure value detected by a pressure sensor that is installed at a low-pressure side of the refrigerant circuit and a change over time of the pressure value.

### TECHNICAL FIELD

The present invention relates to a control device, a compressor, an electric compressor, a belt-driven compressor, a vehicle air conditioner, and a control method.

Priority is claimed on Japanese Patent Application No. 2018-62063 filed on Mar. 28, 2018, the content of which is incorporated herein by reference.

### BACKGROUND ART

A technique has been proposed in which a pressure sensor is installed on a suction side of a compressor of a vehicle air conditioner and protection control of the compressor is activated using a measured pressure value (PTL 1). In PTL 1, the protection control is performed in which the rotation speed of the compressor is decreased in a case where it is detected that a pressure value reaches a negative pressure. PTL 2 discloses a vehicle air conditioner that controls the rotation speed of a compressor such that a suction refrigerant temperature or a suction refrigerant pressure of the compressor is not decreased to a value lower than a target value.

### CITATION LIST

### Patent Literature

[PTL 1] Japanese Unexamined Patent Application Publication No. 2010-13017

[PTL 2] International Publication No. WO 2017/002546

### SUMMARY OF INVENTION

### Technical Problem

However, in the case of a vehicle air conditioner, a suction side pressure may reach a negative pressure even in a case where a compressor is operated normally although depending on various conditions under which a vehicle travels. In a case where protection control is activated based on only on a pressure value or a temperature on a suction side of the compressor, there is a possibility that the protection control may be erroneously activated.

The present invention provides a control device, a compressor, an electric compressor, a belt-driven compressor, a vehicle air conditioner, and a control method with which it is possible to solve the above-described problems.

### Solution to Problem

According to an aspect of the present invention, there is provided a control device including a protection control unit that activates protection control of a compressor included in a refrigerant circuit based on a pressure value measured by a pressure sensor provided on a low-pressure side of the refrigerant circuit and a change over time of the pressure value.

According to the aspect of the present invention, the protection control unit may activate the protection control in a case where a state where the pressure value is a negative pressure within a predetermined range continues for a time equal to or greater than a predetermined time.

According to the aspect of the present invention, the protection control unit may activate the protection control in a case where the pressure value is decreased by a value equal to or greater than a predetermined value in a predetermined time in a state where the pressure value is a negative pressure.

According to the aspect of the present invention, the protection control unit may activate the protection control in a case where the pressure value does not change for a time equal to or greater than a predetermined time while the compressor is being operated.

According to the aspect of the present invention, the protection control unit may cancel the protection control based on a predetermined return condition corresponding to a condition at a time of activation of the protection control.

The control device according to the aspect of the present invention may further include a notification unit that performs notification indicating that cancellation of the protection control is not possible in a case where the protection control unit determines that cancellation of the protection control is not possible.

According to the aspect of the present invention, the protection control unit may control activation of the protection control based on a value obtained by averaging the pressure value.

According to another aspect of the present invention, there is provided a vehicle air conditioner including a compressor and the control device according to any one of the descriptions above, the control device controlling the compressor.

According to still another aspect of the present invention, there is provided a compressor which is used in the vehicle air conditioner described above, the compressor integrally including a pressure sensor that constitutes the control device.

According to still another aspect of the present invention, there is provided a compressor including a compression mechanism, the control device according to any of the descriptions above, and a pressure sensor that is provided on a low-pressure side.

According to still another aspect of the present invention, there is provided an electric compressor integrally including: a motor; a compression mechanism that is driven by the motor; the control device according to any of the descriptions above, the control device controlling the motor; and a pressure sensor that is provided on a low-pressure side, in which the protection control unit activates the protection control by reducing a rotation speed of the motor or stopping the motor.

According to still another aspect of the present invention, there is provided a belt-driven compressor integrally including: a compression mechanism that is driven by power transmitted from a driving source; the control device according to any of the descriptions above, the control device controlling a clutch mechanism that transmits the power of the driving source; and a pressure sensor that is provided on a low-pressure side, in which the protection control unit activates the protection control by causing the clutch mechanism to switch from an ON state to an OFF state.

According to still another aspect of the present invention, there is provided a vehicle air conditioner including the compressor according to any of the descriptions above.

According to still another aspect of the present invention, there is provided a control method including activating protection control of a compressor included in a refrigerant circuit based on a pressure value measured by a pressure sensor provided on a low-pressure side of the refrigerant circuit and a change over time of the pressure value.

### Advantageous Effects of Invention

According to the control device, the compressor, the electric compressor, the belt-driven compressor, the vehicle air conditioner, and the control method described above, it is possible to activate protection control in which malfunction of a compressor is prevented in an appropriate situation without erroneous activation.

### BRIEF DESCRIPTION OF DRAWINGS

FIG. 1 is a diagram showing an example of an air conditioner including an electric compressor in a first embodiment of the present invention.

FIG. 2 is a flowchart showing an example of protection control in the first embodiment of the present invention.

FIG. 3 is a diagram showing an example of an air conditioner including a belt-driven compressor in a second embodiment of the present invention.

FIG. 4 is a first diagram showing an example of a control circuit in the second embodiment of the present invention.

FIG. 5 is a second diagram showing an example of the control circuit in the second embodiment of the present invention.

### DESCRIPTION OF EMBODIMENTS

### First Embodiment

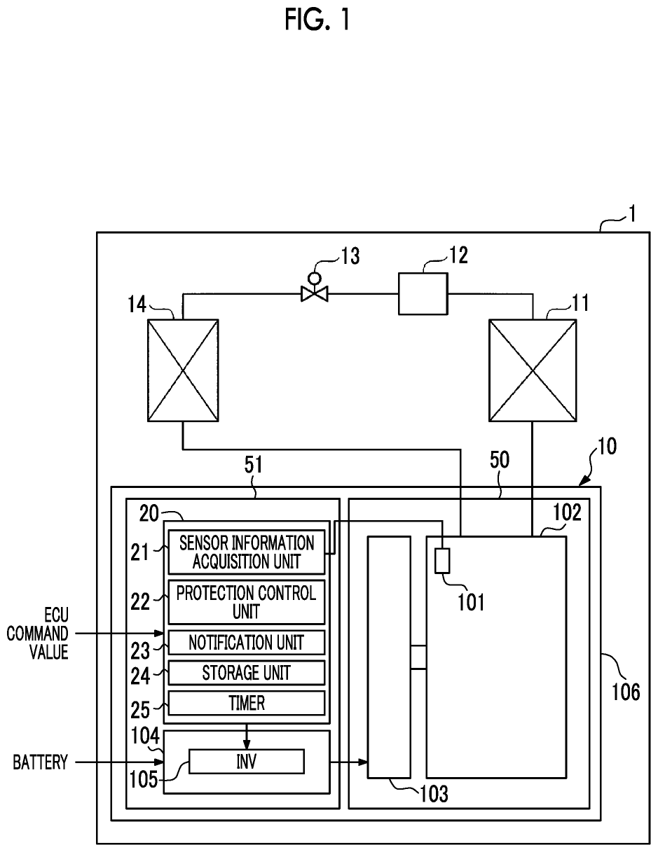

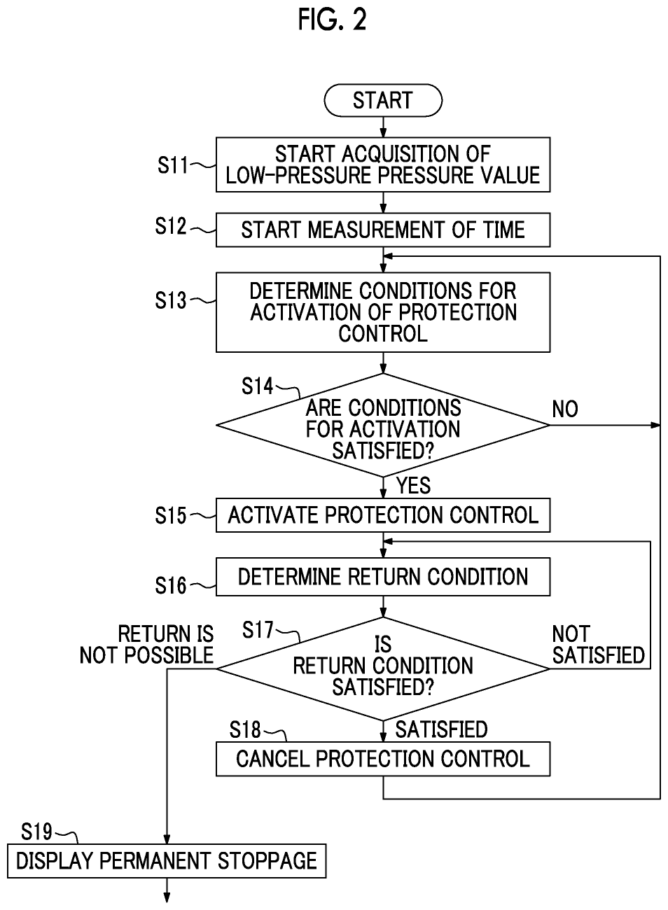

Hereinafter, protection control of a compressor according to a first embodiment of the present invention will be described with reference to FIGS. 1 and 2.

FIG. 1 is a diagram showing an example of an air conditioner including an electric compressor in the first embodiment of the present invention. An air conditioner 1 shown in FIG. 1 is, for example, a vehicle air conditioner. The air conditioner 1 includes an electric compressor 10, a condenser 11, a receiver 12, an expansion valve 13, and an evaporator 14.

The air conditioner 1 is used to heat and cool the inside of a vehicle. The electric compressor 10 compresses a refrigerant and supplies the high-pressure refrigerant to the condenser 11. The refrigerant releases heat and is condensed in the condenser 11. The condensed and liquefied refrigerant flows into the receiver 12. The refrigerant is separated into a gas phase and a liquid phase in the receiver 12. The liquid-phase refrigerant flows out from the receiver 12 and the pressure thereof is decreased in the expansion valve 13. The low-pressure refrigerant passing through the expansion valve 13 is supplied to the evaporator 14. The refrigerant absorbs heat and is gasified through heat exchange with the outside air in the evaporator 14. The gasified refrigerant is sucked into the electric compressor 10. The electric compressor 10 compresses the low-pressure refrigerant and discharges the refrigerant. The electric compressor 10, the condenser 11, the receiver 12, the expansion valve 13, the evaporator 14, and pipes, which connect the electric compressor 10, the condenser 11, the receiver 12, the expansion valve 13, and the evaporator 14 to each other and through which the refrigerant passes, form a refrigerant circuit. With the refrigerant circulating in the refrigerant circuit while repeating the above-described processing, a cooling operation or a heating operation in the vehicle is performed.

The control device 20 controls the rotation speed of the electric compressor 10 based on a command value from an electronic control unit (ECU) (not shown) installed in the vehicle to control the cooling operation or the heating operation so that the temperature in the vehicle reaches a desired temperature. The electric compressor 10 includes a compression function section 50 and a power supply chamber section 51 defined in a housing 106. The electric compressor 10 includes a pressure sensor 101, a compression mechanism 102, and a motor 103 in the compression function section 50. The electric compressor 10 includes a power supply unit 104 and a control device 20 in the power supply chamber section 51, the power supply unit 104 including an inverter (INV) 105 and the control device 20 controlling the inverter 105. The electric compressor 10 is, for example, a scroll compressor.

The pressure sensor 101 is inserted into the housing 106 that constitutes the compression function section 50. The compression function section 50 is an airtight space (airtight portion) in which the refrigerant is sealed and for example, an insertion port of the pressure sensor 101 is sealed with a sealing material or the like. The pressure sensor 101 is provided, for example, in the vicinity of a suction side of the compression mechanism 102 and measures the pressure of a refrigerant before compression (hereinafter, referred to as low-pressure pressure value). The pressure sensor 101 is connected to the control device 20 in the housing 106 and outputs a measured low-pressure pressure value to the control device 20, the control device 20 constituting the power supply chamber section 51.

The compression mechanism 102 includes an orbiting scroll, a fixed scroll, and a compression chamber formed by the scrolls. The motor 103 rotationally drives the compression mechanism 102. The compression mechanism 102 and the motor 103 are connected to each other via a crankshaft. In a case where the motor 103 rotates, the orbiting scroll rotates around the crankshaft and a refrigerant in the compression chamber is compressed. The compression mechanism 102 discharges the refrigerant after the compression.

The power supply unit 104 inputs DC power from a battery installed in the vehicle. The inverter 105 converts the DC power into a three-phase AC and supplies the AC power to the motor 103. The inverter 105 controls a current output to the motor 103 based on an instruction from the control device 20. The control device 20 controls the inverter 105 based on a rotation speed command value of the motor 103 as instructed by the ECU and controls the motor 103 to operate at the rotation speed as instructed. The electric compressor 10 is an inverter-integrated electric compressor into which the pressure sensor 101 and the control device 20 are built.

In a case where the cooling operation or the heating operation is continued, the evaporator may be cooled and frost (frost formation) may be generated. Generally, in a state where frost is generated, control is performed such that the opening degree of the expansion valve 13 is made small and the amount of refrigerant circulation is decreased. As a result, a refrigerant pressure on a suction side of the electric compressor 10 is decreased and the decrease in the refrigerant pressure may cause malfunction of the electric compressor 10 although depending on a degree to which the refrigerant pressure is decreased. In addition, there are various causes of a decrease in pressure on the suction side of the compressor. In the related art, protection control in which a compressor is stopped or a rotation speed is decreased is performed in a case where a pressure value on a suction side (low pressure) of the compressor becomes smaller than a threshold value or a pressure value on a discharge side (high pressure) becomes equal to or greater than the threshold value. In the present embodiment, a pressure sensor is provided at a low-pressure section in a refrigerant space in the electric compressor 10 to monitor a refrigerant low-pressure pressure value. The control device 20 determines whether or not to activate protection control of the electric compressor 10 based on the changes of the low-pressure pressure value or a change over time.

The control device 20 is, for example, a computer including a central processing unit (CPU) such as a microcomputer or a micro processing unit (MPU). As shown in the drawing, the control device 20 includes a sensor information acquisition unit 21, a protection control unit 22, a notification unit 23, a storage unit 24, and a timer 25. As described above, the control device 20 has various functions of controlling the opening degree of the inverter 105 or the expansion valve 13 based on a command value from the ECU (not shown) of the vehicle and performing the cooling operation and the heating operation by means of the air conditioner 1. Hereinafter, description on other than the protection control of the electric compressor 10 will be omitted.

The sensor information acquisition unit 21 acquires the low-pressure pressure value measured by the pressure sensor 101.

The protection control unit 22 activates the protection control of the electric compressor 10 based on the low-pressure pressure value and a change over time in low-pressure pressure value. For example, the protection control unit 22 activates the protection control in a case where a state where the low-pressure pressure value is a negative pressure (pressure lower than atmospheric pressure) continues for a time equal to or greater than a predetermined time. For example, in a case where the low-pressure pressure value is a negative pressure and the low-pressure pressure value is decreased at a rate equal to or greater than a predetermined decreasing rate, the protection control unit 22 activates the protection control. For example, the protection control unit 22 activates the protection control in a case where the low-pressure pressure value does not change for a time equal to or greater than a predetermined time. The protection control unit 22 cancels the protection control in a case where a predetermined return condition is satisfied after the protection control is activated.

The notification unit 23 notifies a user of the state of activation of the protection control or the like. For example, the notification unit 23 notifies the user of activation or cancellation of the protection control or notifies the user that the protection control cannot be canceled.

The storage unit 24 stores various items of information. For example, the storage unit 24 stores the low-pressure pressure value acquired by the sensor information acquisition unit 21, or the like.

The timer 25 measures time.

Next, on the assumption that a configuration as in FIG. 1 is provided, the protection control in the first embodiment will be described.

FIG. 2 is a flowchart showing an example of the protection control in an embodiment of the present invention.

First, the control device 20 starts the operation of the electric compressor 10 in response to a user's instruction operation indicating that air conditioning is to be started. As a result, the pressure sensor 101 starts to measure the low-pressure pressure value. For example, the pressure sensor 101 measures the low-pressure pressure value each time a predetermined time elapses. The sensor information acquisition unit 21 starts to acquire the low-pressure pressure value from the pressure sensor 101 (step S11). The sensor information acquisition unit 21 continues to acquire the low-pressure pressure value each time a predetermined time elapses thereafter. The control device 20 starts to measure time by means of the timer 25 (step S12). The timer 25 measures time. The sensor information acquisition unit 21 records the acquired low-pressure pressure values in the storage unit 24 in association with acquisition times of the low-pressure pressure values, the acquisition times being measured by the timer 25.

Next, the protection control unit 22 performs determination of conditions for activation of the protection control by using values from the low-pressure pressure value measured earlier by a predetermined time to the latest low-pressure pressure value, which are recorded in the storage unit 24 (step S13). At this time, the protection control unit 22 reads the low-pressure pressure values measured over a predetermined period of time from the storage unit 24, calculates an average value per time during which a scroll rotates one time for example, and performs determination of the following conditions for activation based on a change over time in calculated average value. The reason for calculating the average values is to remove the influence of pulsation of refrigerant pressures on the determination of the conditions for activation, the pulsation being generated by rotation of the scroll.

(Condition 1) A state where the low-pressure pressure value is a negative pressure while being in a predetermined range continues for a predetermined time.

For example, in a case where a state where the low-pressure pressure value is equal to or lower than −0.03 MPaG continues for 30 seconds or more, the protection control unit 22 determines to activate the protection control. In a case where a state where the low-pressure pressure value is equal to or lower than −0.03 MPaG continues for 30 seconds or more, there is a high possibility that the evaporator 14 is frozen. If the evaporator 14 is frozen, the expansion valve 13 is closed and thus no refrigerant gas flows into the electric compressor 10 or the amount of refrigerant gas flowing into the electric compressor 10 is decreased. As a result, it becomes difficult to supply a refrigerant or lubricant to the electric compressor 10. In a case where the electric compressor 10 is continuously operated in this state, there is a possibility that the electric compressor 10 is damaged by being burned or like. Therefore, in a case where “Condition 1” as described above is satisfied, the protection control unit 22 determines that the protection control of the electric compressor 10 is to be performed.

In the related art, there is control in which protection control is activated in a case where a pressure measured by a pressure sensor reaches a negative pressure, the pressure sensor being provided in a pipe on a suction side of a compressor. However, in the case of such control, a negative pressure may be detected temporarily even in a state where no evaporator is frozen and thus the protection control may be performed unnecessarily in such a case. There is control in which whether or not an evaporator is frozen is estimated based on a temperature measured by a temperature sensor and protection control is activated, the temperature sensor being provided in the vicinity of the evaporator. Usually, the temperature sensor is installed in the vicinity of a portion of the evaporator at which a temperature decrease is largest and to prevent the evaporator from being frozen, in a case where a temperature equal to or greater than 0° C. (for example, 2° C.) is detected, the protection control is activated such that the evaporator is prevented from being frozen. However, for example, in a case where the position of the temperature sensor is inappropriate or in a case where there is a change in temperature distribution of the evaporator attributable to operating conditions and a temperature decrease becomes largest at a place other than the vicinity of a place at which the temperature sensor is installed, no cold air from the evaporator reaches the temperature sensor in a case where the evaporator is frozen and freezing develops up to the vicinity of the temperature sensor and there is a possibility that a temperature higher than the actual temperature of the evaporator is measured. As a result, there is a possibility that the protection control is not activated, the evaporator is frozen, and the compressor malfunctions. In the case of the electric compressor 10 in the present embodiment, since a pressure at a low-refrigerant pressure section is directly measured by means of the pressure sensor 101 inserted into the compression mechanism 102, a low-pressure pressure value that is a negative pressure can be reliably detected and the protection control is activated after confirming that such state has continued for a certain time. Accordingly, it is possible to prevent erroneous activation of the protection control which may occur in the case of the related art. The low-pressure pressure value in “Condition 1”, can be set in a range of −0.03 to −0.04 MPaG in accordance with operating conditions. The time of the continuation in Condition 1 can be set in a range of 5 to 30 seconds.

(Condition 2) A decrease in pressure equal to or greater than a predetermined value is made in a predetermined time in a state where the low-pressure pressure value is a negative pressure.

For example, in a case where the low-pressure pressure value is decreased to −0.05 MPaG from 0 MPaG in five seconds, the protection control unit 22 determines that the protection control is to be activated. In a case where the low-pressure pressure value becomes a negative pressure and is decreased rapidly, there is a high possibility that a foreign matter has entered somewhere in the refrigerant circuit with the expansion valve 13 being clogged with a fine foreign matter or the like and that the refrigerant circuit is closed. In a case where the electric compressor is operated in this state, malfunction may occur. Therefore, the protection control unit 22 determines whether or not to activate the protection control based on “Condition 2” as above. Accordingly, it is possible to protect the electric compressor 10 at a high accuracy.

In a case where the electric compressor 10 is to be activated, the electric compressor 10 needs to be activated after a shut-off valve enters an opened state in a case where the shut-off valve is provided in the refrigerant circuit. Even in a case where the electric compressor 10 is erroneously activated with the shut-off valve closed for some reason, it is possible to quickly activate the protection control of the electric compressor 10 and prevent the electric compressor 10 from being damaged due to “Condition 2”. The temporal condition in “Condition 2” can be set in a range of 5 to 10 seconds.

(Condition 3) The low-pressure pressure value does not change for a predetermined time during the operation of the electric compressor 10.

In a case where a state where the low-pressure pressure value is not changed is observed when the electric compressor 10 is operated, the protection control is activated. For example, in a case where the pressure is the same as a pressure before activation even when the electric compressor 10 is operated, there may be compressor malfunction. In such a case, the compressor is stopped. In the related art, there is provided a lock sensor that detects whether or not a compressor is locked by detecting whether or not a component in the compressor is not operated by means of an eddy-current proximity sensor or the like, the eddy-current proximity sensor or the like being installed in the compressor. In the present embodiment, such detection is performed by means of the pressure sensor 101. In a case where the electric compressor 10 is locked for some reason, the compression mechanism 102 sucks in no refrigerant gas. In a case where no refrigerant gas is sucked in, there is no change in low-pressure pressure value measured by the pressure sensor 101. According to the protection control in the present embodiment, it is possible to detect whether or not a compressor is locked through determination of “Condition 3” without installation of a lock sensor.

The protection control unit 22 performs determination of “Condition 1” to “Condition 3” while referring to time series data of the low-pressure pressure values recorded in the storage unit 24. In a case where none of “Condition 1” to “Condition 3” is satisfied (step S14: No), the protection control unit 22 repeats the determination in step S13. The electric compressor 10 continues a normal operation.

In a case where any of “Condition 1” to “Condition 3” is satisfied (step S14: Yes), the protection control unit activates the protection control (step S15). The protection control is stoppage of the electric compressor or reduction of the rotation speed of the electric compressor 10. The protection control unit 22 may instruct the inverter 105 to reduce the speed of the motor 103 or stop the motor 103 in accordance with which condition is satisfied. For example, in a case where “Condition 1” is satisfied, the protection control unit 22 instructs the inverter 105 to drive the motor 103 at a predetermined low rotation speed. With rotation at a low speed, a decrease in low-pressure pressure value can be prevented. For example, in a case where “Condition 2” or “Condition 3” is satisfied, the protection control unit 22 instructs the inverter 105 to stop the motor 103. With the electric compressor 10 stopped, damage to the compressor can be prevented. The protection control unit 22 records an activation start time of the protection control in the storage unit 24.

In a case where the protection control is activated, the protection control unit 22 performs determination of a return condition for canceling the protection control and causing the electric compressor 10 to return to a normal operation state (step S16). For example, the protection control unit 22 determines whether or not to cancel the protection control based on a return condition corresponding to a condition at the time of determination made in step S14 that the protection control is to be activated. For example, in a case where it is determined that the protection control is to be activated based on “Condition 1”, the protection control unit 22 determines that a return condition is satisfied if a predetermined set time elapses after the activation start time of the protection control. As the predetermined time, for example, a time required for freezing to settle down is set in a range of 5 seconds to 120 seconds. For example, in a case where it is determined that the protection control is to be activated based on “Condition 2” or “Condition 3”, the protection control unit 22 determines that permanent stoppage (no automatic return to normal operation) is to be made. This is because the electric compressor 10 cannot be operated as long as a cause of a foreign matter entering the refrigerant circuit or the locking of the compressor is not removed. Regarding “Condition 2” or “Condition 3”, for confirmation, the protection control unit 22 may activate the electric compressor 10 at a rotation speed at which a possibility of damage is low to determine whether or not “Condition 2” or “Condition 3” is satisfied. For example, in a case where “Condition 2” or “Condition 3” is satisfied three times consecutively, the protection control unit 22 determines that permanent stoppage is to be made (cancellation of protection control is not possible) and if the conditions are not satisfied at the time of reactivation, a normal operation may be restarted.

In a case where the return condition is satisfied (step S17: satisfied), the protection control unit 22 cancels the protection control (step S18) and restarts a normal operation. This corresponds to a case where the predetermined set time (5 seconds to 120 seconds) elapses after the start of the protection control based on “Condition 1” or a case where a phenomenon corresponding to “Condition 2” or “Condition 3” does not occur again in a case where reactivation is performed for confirmation after the protection control is started based on “Condition 2” or “Condition 3” from among the above examples. In a case where a normal operation is restarted, the control device 20 performs control in which the motor 103 is rotated at a rotation speed according to an ECU command value, for example. While the control device 20 is performing the normal operation, the protection control unit 22 continues to monitor the low-pressure pressure values to perform the determination in step S13. In a case where no return condition is satisfied (step S17: not satisfied), the protection control unit 22 waits until the determination in step S16 is satisfied. This corresponds to a period of time between when the protection control is started based on “Condition 1” and when the predetermined set time (5 seconds to 120 seconds) elapses from among the above examples.

In a case where a return is not possible (step S17: return is not possible), the notification unit 23 notifies a user that the electric compressor 10 is in an abnormal state and activation of the electric compressor 10 is not possible (step S19). For example, the ECU may receive notification from the notification unit 23 to cause a display device at a driver's seat to display a message indicating that the electric compressor 10 is in an abnormal state or inspection of the electric compressor 10 is to be made or to turn on a lamp. This corresponds to a case where “Condition 2” or “Condition 3” is satisfied or a case where a phenomenon where “Condition 2” or “Condition 3” is satisfied occurs again even in a case where reactivation is performed for confirmation from among the above examples.

As described above, the electric compressor 10 in the present embodiment integrally includes the pressure sensor 101 that detects a pressure on a low-pressure side, a compressor body (compression mechanism 102 and motor 103), and the control device 20. Since the electric compressor 10 includes the control device 20, the electric compressor 10 can activate the protection control autonomously.

Since a configuration in which the pressure sensor 101 is provided in a compressor airtight portion is adopted, it is possible to perform control based on an accurate refrigerant pressure and prevent erroneous determination in comparison with a case where protection control is activated based on a value measured by a pressure sensor provided in a suction side pipe outside a compressor or a temperature sensor provided in the vicinity of an evaporator. Since the control is performed based on the average values of values measured by the pressure sensor 101, it is possible to reduce the influence of the pulsation of pressure values caused by a scroll.

In the same manner as the pressure sensor 101, a pressure sensor may be provided on a high-pressure side of the electric compressor 10 to be able to directly measure the pressure of a refrigerant and the protection control may be activated in a case where a pressure on the high-pressure side becomes equal to or greater than a threshold value, for example.

According to the present embodiment, the protection control is activated based on not only the fact that the low-pressure pressure value has become a negative pressure but also a change over time of the negative low-pressure pressure value that has become the negative pressure. Therefore, it is possible to prevent erroneous activation of the protection control and to realize efficient operation of the electric compressor 10 and the air conditioner 1 while preventing malfunction of the electric compressor 10.

### Second Embodiment

In the first embodiment, the protection control has been described while using the electric compressor 10 as an example. In a vehicle air conditioner, a belt-driven compressor which obtains a compressor driving force from an engine of a vehicle is used in many cases. In a second embodiment, a belt-driven compressor 10a will be described. The same components as those in the first embodiment are given the same reference numerals and the description thereof will be omitted.

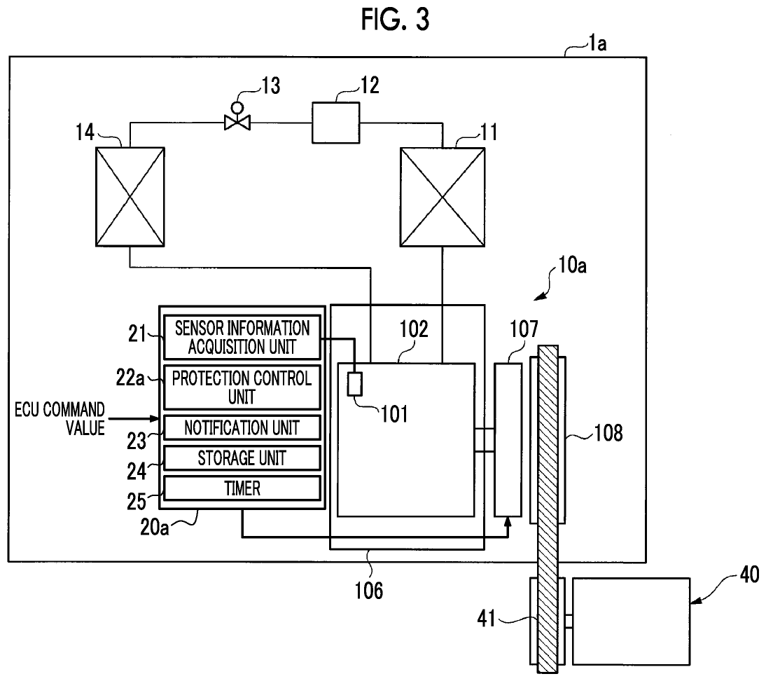

FIG. 3 is a diagram showing an example of an air conditioner including a belt-driven compressor in the second embodiment of the present invention. An air conditioner 1a shown in FIG. 3 includes the belt-driven compressor 10a, the condenser 11, the receiver 12, the expansion valve 13, and the evaporator 14. The belt-driven compressor 10a includes the pressure sensor 101, the compression mechanism 102, a magnet clutch 107, a pulley portion 108, and a control device 20a that controls the magnet clutch 107. Among them, at least the pressure sensor 101 and the compression mechanism 102 are stored in the housing 106 and the pressure sensor is installed in a region where the pressure of a refrigerant becomes low at the time of operation. The control unit 20a is installed on an outer surface of a low-pressure side housing. The belt-driven compressor 10a is, for example, a scroll compressor. A rotating shaft of the compression mechanism 102 and the magnet clutch 107 are connected to each other. The pulley portion 108 is connected to an engine 40 of a vehicle by a belt 41. The compression mechanism 102 and the pulley portion 108 can be connected and disconnected to and from each other by means of the magnet clutch 107.

In a case where the control device 20a turns on the magnet clutch 107, the magnet clutch 107 and the pulley portion 108 are engaged with each other. In a case where the magnet clutch 107 is in an ON state, rotation of the engine 40 is transmitted to the belt 41 and the pulley portion 108, the magnet clutch 107, and the rotating shaft of the compression mechanism 102 are rotated. As a result, in the compression mechanism 102, an orbiting scroll rotates and a refrigerant is compressed. That is, the belt-driven compressor 10a enters an operation state.

In a case where the control device 20a turns off the magnet clutch 107, the magnet clutch 107 and the pulley portion 108 are disconnected from each other. In a case where the magnet clutch 107 is in an OFF state, the pulley portion 108 rotates idly due to rotation of the engine 40. At this time, the belt-driven compressor 10a enters a stopped state.

The control device 20a controls transmission of power to the compression mechanism 102 by causing the magnet clutch 107 to switch between the ON state and the OFF state based on a command value from the electronic control unit (ECU) (not shown), the power being supplied from the engine 40. With the power from the engine 40 transmitted to the compression mechanism 102, the compression mechanism 102 is operated and a cooling operation or a heating operation is performed such that the inside of the vehicle reaches a predetermined temperature. In a case where air conditioning is not necessary, the control device 20a turns off the magnet clutch 107. The pressure sensor 101 is inserted into an airtight portion on a low-pressure side of the compression mechanism 102 and measures the low-pressure pressure value. As with the first embodiment, the pressure sensor 101 is connected to the control device 20a and outputs the measured low-pressure pressure value to the control device 20a. The belt-driven compressor 10a is an integrated type belt-driven compressor into which the pressure sensor 101 and the control device 20a are built.

The control device 20a includes the sensor information acquisition unit 21, a protection control unit 22a, the notification unit 23, the storage unit 24, and the timer 25. The functions of the sensor information acquisition unit 21, the notification unit 23, the storage unit 24, and the timer 25 are the same as those in the first embodiment.

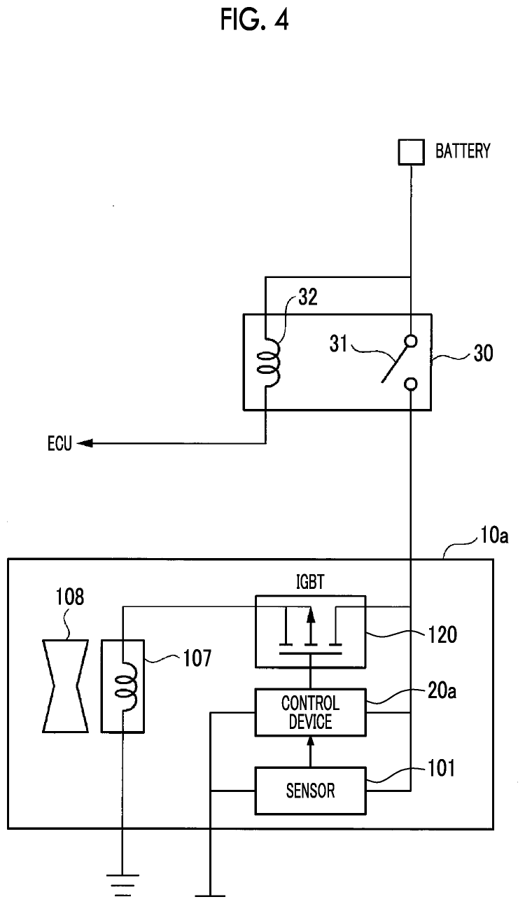

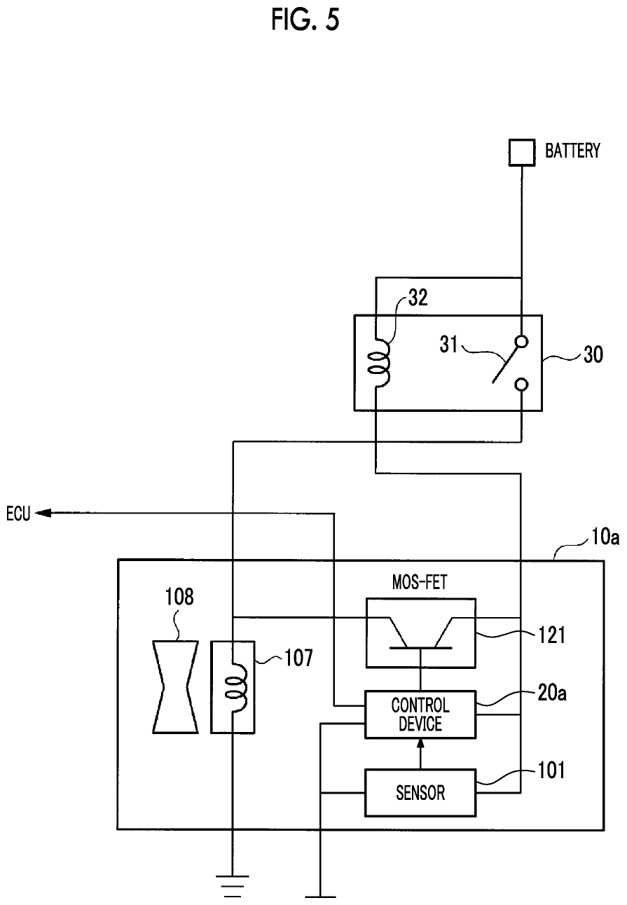

The protection control unit 22a activates the protection control of the belt-driven compressor 10a based on the low-pressure pressure value and a change over time in low-pressure pressure value. For example, the protection control unit 22a determines whether to activate the protection control based on “Condition 1” to “Condition 3” described in FIG. 2. In a case where the protection control is to be activated, the protection control unit 22a turns off the magnet clutch 107 so that the belt-driven compressor 10a is disconnected from the engine 40. The protection control unit 22a performs the protection control by stopping the belt-driven compressor 10a in this manner. The protection control unit 22a cancels the protection control in a case where a predetermined return condition is satisfied after the protection control is activated. In a case where the protection control is to be canceled, the protection control unit 22a turns on the magnet clutch 107 so that the belt-driven compressor 10a and the engine 40 are connected to each other via the belt 41. As with the first embodiment, the protection control unit 22a may perform control based on values obtained by averaging values measured by the pressure sensor 101 in units of rotation cycles of the orbiting scroll. FIGS. 4 and 5 show a control circuit of a clutch mechanism including the control device 20a, the magnet clutch 107, and the pulley portion 108.

FIG. 4 is a first diagram showing an example of the control circuit in the second embodiment of the present invention.

As shown in FIG. 4, a battery included in the vehicle is connected to the control device 20a, the pressure sensor 101, and a switching element 120 via a relay 30. The relay 30 is provided outside the belt-driven compressor 10a. The switching element 120 is provided inside the belt-driven compressor 10a. The relay 30 includes a relay switch 31 and a relay coil 32. In a case where the ECU causes an electric current to flow to the relay coil 32, the relay switch 31 is turned on and the control device 20a, the pressure sensor 101, and the switching element 120 are energized. For example, the switching element 120 is composed of an insulated-gate bipolar transistor (IGBT). The magnet clutch 107 is connected to the battery of the vehicle via the switching element 120. In other words, in a case where the relay 30 is in an ON state and the switching element 120 is in an OFF state, the magnet clutch 107 is turned on, the magnet clutch 107 and the pulley portion 108 are engaged with each other, and it becomes possible for the rotation of the engine 40 to be transmitted to the compression mechanism 102.

The ON state and the OFF state of the switching element 120 are controlled by the control device 20a. In other words, in a case where the control device 20a receives an instruction signal indicating the belt-driven compressor 10a is to be operated from the ECU and where the protection control unit 22a does not activate the protection control, the control device 20a controls the switching element 120 such that the switching element 120 is turned on based on an instruction from the ECU. As a result, the magnet clutch 107 is energized and is engaged with the pulley portion 108. Accordingly, the compression mechanism 102 is rotated and refrigerant compression is performed. Meanwhile, in a case where the protection control unit 22a activates the protection control, the control device 20a controls the switching element 120 such that the switching element 120 is turned off. As a result, the magnet clutch 107 is disconnected from the pulley portion 108 and the belt-driven compressor 10a enters an inoperation state. Accordingly, negative-pressure operation of the belt-driven compressor 10a is suppressed and thus malfunction or damage can be avoided.

FIG. 5 is a second diagram showing an example of the control circuit in the second embodiment of the present invention.

As shown in FIG. 5, the battery included in the vehicle is connected to the control device 20a, the pressure sensor 101, and a switching element 121 via the relay 30. The battery and the magnet clutch 107 are connected to each other via the switching element 121 and the relay 30. The relay 30 is provided outside the belt-driven compressor 10a. The switching element 121 is provided inside the belt-driven compressor 10a. The relay 30 includes the relay switch 31 and the relay coil 32. For example, the switching element 121 is composed of a MOS-FET, which is less expensive than the IGBT shown in FIG. 4. In a case where the switching element 121 is turned on, an electric current flows to the relay coil 32 and the relay switch 31 is turned on. In a case where the relay switch 31 is turned on, the control device 20a, the pressure sensor 101, and the magnet clutch 107 are energized from the battery. In this state, the magnet clutch 107 is turned on, the magnet clutch 107 and the pulley portion 108 are engaged with each other, and it becomes possible for the rotation of the engine 40 to be transmitted to the compression mechanism 102.

The ON state and the OFF state of the switching element 121 are controlled by the control device 20a. In other words, in a case where the control device 20a receives an instruction signal indicating the belt-driven compressor 10a is to be operated from the ECU and where the protection control unit 22a does not activate the protection control, the control device 20a controls the switching element 121 such that the switching element 121 is turned on based on an instruction from the ECU. As a result, the relay 30 is turned on, power is supplied from the battery to the magnet clutch 107, and the magnet clutch 107 is engaged with the pulley portion 108. Accordingly, the compression mechanism 102 is rotated and refrigerant compression is performed. Meanwhile, in a case where the protection control unit 22a activates the protection control, the control device 20a controls the switching element 121 such that the switching element 121 is turned off. As a result, the magnet clutch 107 is disconnected from the pulley portion 108 and the belt-driven compressor 10a enters an inoperation state. Accordingly, negative-pressure operation of the belt-driven compressor 10a is suppressed and thus malfunction or damage can be avoided.

In the related art, a configuration, in which the battery and the magnet clutch 107 are connected to each other via the relay 30 and the magnet clutch 107 is caused to switch between an ON state and an OFF state by means of energization of the relay coil 32 performed by the ECU, is adopted generally. In the case of the belt-driven compressor 10a, as shown in FIGS. 4 and 5, the switching element is provided between the magnet clutch 107 and the relay 30 and the switching element may be caused to switch between an ON state and an OFF state based on determination performed by the protection control unit 22a. Such a control circuit can be mounted through relatively easy wiring processing or the like.

The protection control unit 22a determines whether or not the protection control is to be activated and whether or not a return is to be made in the same manner as in the processing described with reference to FIG. 2 of the first embodiment.

A scroll compressor is higher in performance (amount of discharge) at the time of high-speed rotation than other types of compressors and thus is used in a vehicle air conditioner in many cases. In a case where a belt-driven scroll compressor is used, the rotation speed increases rapidly at the time of sudden acceleration of a vehicle or the like and operation thereof becomes operation in a high-speed range. Since the amount of discharge becomes large at the time of operation in a high-speed range (at time of high-speed rotation), a large amount of refrigerant is sucked in and thus the low-pressure pressure value may become a low pressure equal to or smaller than a negative pressure in a short time even in a state where an evaporator is not frozen. In a case where control in the related art in which protection control is activated if a pressure on a compressor suction side becomes a negative pressure is performed with respect to a scroll compressor, there is a problem that the compressor is frequently stopped or decelerated in such a case also.

A belt-driven compressor is operated by being driven by an engine and connection and disconnection between the belt-driven compressor and the engine are controlled by an ECU in many cases. Since it is not possible for a compressor to independently activate protection control, there may be a problem that the protection control is not able to be activated in a situation where the protection control is to be activated and thus the compressor may be damaged.

According to the present embodiment, the belt-driven compressor 10a is configured to integrally include the pressure sensor 101, the compression mechanism 102, a clutch mechanism (magnet clutch 107 and pulley portion 108) connecting the compression mechanism 102 and a driving source (engine 40), and the control device 20a controlling the clutch mechanism. Therefore, the belt-driven compressor 10a can autonomously activate the protection control and thus malfunction can be prevented.

According to the present embodiment, the protection control is activated based on a change over time of the negative low-pressure pressure value that has become a negative pressure. Therefore, even in a case where a negative pressure is temporarily measured at the time of sudden acceleration or the like of the vehicle, the protection control is not erroneously activated. According to the present embodiment, a special lock detection device is not necessary since low-pressure protection control of the compressor with respect to freezing of the evaporator and clogging of the refrigerant circuit is possible without erroneous activation and determination on whether or not the compressor 10a is in a locked state is possible.

Since a configuration in which the pressure sensor 101 is provided in the airtight portion is adopted, it is possible to determine whether or not to activate the protection control based on an accurate refrigerant pressure. In addition, the belt-driven compressor 10a exhibits the same effects as the electric compressor 10 in the first embodiment. A pressure sensor may be provided on a high-pressure side of the belt-driven compressor 10a to be able to directly measure the pressure of a refrigerant and the protection control may be activated in a case where a pressure on the high-pressure side becomes equal to or greater than a threshold value, for example.

Furthermore, the control device 20a including the switching element is directly installed on the outer surface of the housing 106 on the low-pressure side of the compressor 10a, heat generation of an element can be cooled and thus reliability is improved.

All or part of the functions of the control devices 20 and 20a may be realized by, for example, hardware composed of a large scale integration (LSI), an application specific integrated circuit (ASIC), a programmable logic device (PLD), a field-programmable gate array (FPGA), an integrated circuit, or the like. All or part of the functions of the control devices 20 and 20a may be configured by a computer including a processor such as a CPU. In this case, each processing in the control devices 20 and 20a can be realized by the CPU or the like of the control device 20 executing a program, for example. The program executed by the control devices 20 and 20a is recorded in a computer-readable recording medium and the realization may be made by reading the program recorded in the recording medium.

In the first embodiment and the second embodiment above, an example in which protection operation is autonomously performed not via the ECU of the vehicle has been disclosed. However, a configuration in which the ECU is directly notified of information about the pressure sensor 101 or the control devices 20 and 20a and comprehensive control is performed may also be adopted.

In addition, without departing from the spirit of the present invention, the components in the above embodiments can be appropriately replaced with known components. The technical scope of the present invention is not limited to the above embodiments, and various modifications can be made without departing from the spirit of the present invention.

### INDUSTRIAL APPLICABILITY

According to the control device, the compressor, the electric compressor, the belt-driven compressor, the vehicle air conditioner, and the control method described above, it is possible to activate protection control in which malfunction of a compressor is prevented in an appropriate situation without erroneous activation.

### REFERENCE SIGNS LIST

1, 1a air conditioner
10 electric compressor
10a belt-driven compressor
11 condenser
12 receiver
13 expansion valve
14 evaporator
20, 20a control device
21 sensor information acquisition unit
22, 22a protection control unit
23 notification unit
24 storage unit
25 timer
30 relay
31 relay switch
32 relay coil
40 engine
41 belt
101 pressure sensor
102 compression mechanism
103 motor
105 inverter
104 power supply unit
106 housing
107 magnet clutch
108 pulley portion
120, 121 switching element

1. A control device comprising:
a protection control unit that activates protection control of a compressor included in a refrigerant circuit based on a pressure value measured by a pressure sensor provided on a low-pressure side of the refrigerant circuit and a change over time of the pressure value.

2. The control device according to claim 1,
wherein the protection control unit activates the protection control in a case where a state where the pressure value is a negative pressure within a predetermined range continues for a time equal to or greater than a predetermined time.

3. The control device according to claim 1,
wherein the protection control unit activates the protection control in a case where the pressure value is decreased by a value equal to or greater than a predetermined value in a predetermined time in a state where the pressure value is a negative pressure.

4. The control device according to claim 1,
wherein the protection control unit activates the protection control in a case where the pressure value does not change for a time equal to or greater than a predetermined time while the compressor is being operated.

5. The control device according to claim 1,
wherein the protection control unit cancels the protection control based on a predetermined return condition corresponding to a condition at a time of activation of the protection control.

6. The control device according to claim 1, further comprising:
a notification unit that performs notification indicating that cancellation of the protection control is not possible in a case where the protection control unit determines that cancellation of the protection control is not possible.

7. The control device according to claim 1,
wherein the protection control unit controls activation of the protection control based on a value obtained by averaging the pressure value.

8. A vehicle air conditioner comprising:
a compressor; and
the control device according to claim 1, the control device controlling the compressor.

9. A compressor which is used in the vehicle air conditioner according to claim 8, the compressor integrally comprising:
a pressure sensor that constitutes the control device.

10. A compressor comprising:
a compression mechanism;
the control device according to claim 1; and
a pressure sensor that is provided on a low-pressure side.

11. An electric compressor integrally comprising:
a motor;
a compression mechanism that is driven by the motor;
the control device according to claim 1, the control device controlling the motor; and
a pressure sensor that is provided on a low-pressure side,
wherein the protection control unit activates the protection control by reducing a rotation speed of the motor or stopping the motor.

12. A belt-driven compressor integrally comprising:
a compression mechanism that is driven by power transmitted from a driving source;
the control device according to claim 1, the control device controlling a clutch mechanism that transmits the power of the driving source; and
a pressure sensor that is provided on a low-pressure side,
wherein the protection control unit activates the protection control by causing the clutch mechanism to switch from an ON state to an OFF state.

13. A vehicle air conditioner comprising:
the compressor according to claim 1.

14. A control method comprising:
activating protection control of a compressor included in a refrigerant circuit based on a pressure value measured by a pressure sensor provided on a low-pressure side of the refrigerant circuit and a change over time of the pressure value.
